(19) United States
(12) Patent Application Publication
(10) Pub. No.: US 2026/0031853 A1
(43) Pub. Date: Jan. 29, 2026

(54) HYBRID FIRA MODE OF OPERATIONS

(71) Applicant: Cisco Technology, Inc., San Jose, CA (US)

(72) Inventors: Jerome Henry, Pittsboro, NC (US); Ardalan Alizadeh, Milpitas, CA (US); Peiman Amini, Fremont, CA (US); Robert Edgar Barton, Richmond (CA)

(21) Appl. No.: 19/189,883

(22) Filed: Apr. 25, 2025

Related U.S. Application Data
(60) Provisional application No. 63/676,174, filed on Jul. 26, 2024.

(51) Int. Cl. H04B 1/7163; H04W 56/00

(52) U.S. Cl. CPC H04B 1/7163; H04W 56/001

(57) ABSTRACT

In one aspect, a controller associated with an Ultra-Wide Band (UWB) network may analyze plurality of ranging methods utilized by a plurality of anchors of the UWB network to synchronize respective timings for tracking one or more tags in a geographic area. The controller may also determine a first ranging round structure that accommodates a first pair of ranging methods of the plurality of ranging methods. The first pair of ranging methods may include two distinct ranging methods of the plurality of ranging methods. The controller may transmit a first synchronization signal based on the first ranging round structure to at least a subset of the plurality of anchors to synchronize transmissions associated with tracking the one or more tags.

### CROSS REFERENCE TO RELATED APPLICATIONS

This application claims priority to U.S. Patent Application No. 63/676,174, filed Jul. 26, 2024, entitled “HYBRID FIRA MODE OF OPERATIONS,” which is incorporated by reference herein in its entirety.

### TECHNICAL FIELD

The present technology pertains to ultra-wide band technology, and, more specifically, to different FiRa block structures for accommodating different FiRa ranging methods on a single network.

### BACKGROUND

Ultra-Wide Band (UWB) is a wireless technology that enables accurate indoor positioning and location-based services, up to 10 cm precise, even in challenging indoor environments which makes it ideally suited to enable real-time measurement of location, distance, and direction, while also supporting two-way communication. IEEE 802.15.4 standard for wireless communication defines the operations of UWB. A widely adopted UWB-based standards is Fine Ranging (FiRa) consortium. FiRa Consortium is an industry alliance focused on promoting the adoption and interoperability of Ultra-Wideband (UWB) technology for secure, high-precision location-based services. FiRa's primary goal is to ensure seamless UWB integration across various consumer and enterprise applications. FiRa is consumer-driven, focusing on secure, short-range communication for devices like smartphones, smart access, and IoT applications.

### BRIEF DESCRIPTION OF THE DRAWINGS

To easily identify the discussion of any particular element or act, the most significant digit or digits in a reference number refer to the figure number in which that element is first introduced.

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings, and the claims.

FIG. 1 illustrates an example environment operating based on FiRa (UWB) standard, according to some aspects of the present disclosure.

FIG. 2A illustrates a FiRa structure according to some aspects of the present disclosure.

FIG. 2B illustrates a FiRa structure according to some aspects of the present disclosure.

FIG. 2C illustrates a FiRa structure according to some aspects of the present disclosure.

FIG. 2D illustrates a FiRa structure according to some aspects of the present disclosure.

FIG. 3 illustrates a method for implementing a FiRa structure according to some aspects of the present disclosure.

FIG. 4 shows an example of a system for implementing certain aspects of the present technology.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

A used herein the term “configured” shall be considered to interchangeably be used to refer to configured and configurable unless the term “configurable” is explicitly used to distinguish from “configured.” The proper understanding of the term will be apparent to persons of ordinary skill in the art in the context in which the term is used.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Aspects of the present disclosure can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IOT) network.

It should be noted that throughout the present disclosure, references are being made to FiRa, and these references are not meant to be limited to the specific FiRa consortium per se, but simply as an exemplary UWB specifications/standards. The present disclosure encompasses any future organizations that provide UWB specifications directed to industrial environment and applications, consumer-drive, etc. (an example of which is provided through FiRa consortium).

### Overview

In one aspect, a controller associated with an Ultra-Wide Band (UWB) network may analyze plurality of ranging methods utilized by a plurality of anchors of the UWB network to synchronize respective timings for tracking one or more tags in a geographic area. The controller may also determine a first ranging round structure that accommodates a first pair of ranging methods of the plurality of ranging methods. The first pair of ranging methods may include two distinct ranging methods of the plurality of ranging methods. The controller may transmit a first synchronization signal based on the first ranging round structure to at least a subset of the plurality of anchors to synchronize transmissions associated with tracking the one or more tags.

In another aspect, the controller may determine a second ranging round structure that accommodates a second pair of ranging methods of the plurality of ranging methods. The first pair of ranging methods may include two distinct ranging methods of the plurality of ranging methods. The controller may transmit a second synchronization signal based on the second ranging round structure to at least the subset of the plurality of anchors. The second ranging round structure may be sequential to the first ranging round structure. The second ranging round structure may accommodate a second pair of ranging methods and the second pair of ranging methods may be comprised of two distinct ranging methods of the plurality of ranging methods.

In another aspect, the second ranging round structure may be different from the first ranging round structure. The second pair of ranging methods may be distinct from the first pair of ranging methods.

In another aspect, the controller may transmit instructions associated with the first ranging round structure or the second ranging round structure to at least the subset of the plurality of anchors of the UWB network.

In another aspect, the first ranging round structure is transmitted by the controller using an out-of-band method.

In another aspect, the plurality of ranging methods may include at least Two-Way Ranging (TWR), Uplink Time Difference of Arrival (UL TDoA), and Downlink TDoA (DL TDoA).

In another aspect, the first ranging round structure may be sub-divided into one or more segments. Each segment of the one or more segments may be associated with at least one of a respective ranging method and a synchronization signal.

In one aspect, a system may include one or more processors and memory storing instructions that, when executed by the one or more processors, configure the system to analyze plurality of ranging methods utilized by a plurality of anchors of the UWB network to synchronize respective timings for tracking one or more tags in a geographic area. The system may also determine a first ranging round structure that accommodates a first pair of ranging methods of the plurality of ranging methods. The first pair of ranging methods may include two distinct ranging methods of the plurality of ranging methods. The system may transmit a first synchronization signal based on the first ranging round structure to at least a subset of the plurality of anchors to synchronize transmissions associated with tracking the one or more tags. In one aspect, a non-transitory computer-readable storage medium may include instructions that when executed by a computer, cause the computer to analyze a plurality of ranging methods utilized by a plurality of anchors of the UWB network to synchronize respective timings for tracking one or more tags in a geographic area. The computer may also determine a first ranging round structure that accommodates a first pair of ranging methods of the plurality of ranging methods. The first pair of ranging methods may include two distinct ranging methods of the plurality of ranging methods. The computer may transmit a first synchronization signal based on the first ranging round structure to at least a subset of the plurality of anchors to synchronize transmissions associated with tracking the one or more tags.

Other technical features may be readily apparent to one skilled in the art from the following figures, descriptions, and claims.

### Example Embodiments

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The disclosed technology addresses the need in the art for clear guidelines for combining Two-Way Ranging (TWR), Uplink Time Difference of Arrival (UL TDoA), and Downlink TDoA (DL TDoA) within a single Fine Ranging (FiRa) implementation. The FiRa Consortium has not specified combined modes of operation that integrate different ranging methods such as TWR, UL TDoA, and DL TDoA. This limitation is particularly problematic in applications such as hospitals, where asset tags must be reliably and accurately identified (via UL-TDoA and/or TWR) and tracked by user handheld devices (via indoor navigation of DL-TDoA) to be physically identified. Without a defined method to mix these ranging modes, it becomes challenging to manage different types of exchanges and ensure synchronization across modes. In such mixed environments where multiple ranging modes need to coexist, the lack of clear guidelines leads to increased complexity and potential for collisions. This results in suboptimal use of resources and reduced efficiency. Therefore, there is a critical need for a method that supports a FiRa UL TDoA scheme accommodating different ranging approaches while integrating and utilizing multiple ranging modes within FiRa. This will enhance the operational flexibility and efficiency of FiRa-based positioning systems, making them more reliable and effective in diverse application scenarios.

The disclosed technology involves a hybrid FiRa mode of operations that integrates different ranging methods such as Downlink Time Difference of Arrival (DL TDoA), Uplink Time Difference of Arrival (UL TDoA), and Two-Way Ranging (TWR) within a single FiRa implementation. A central entity, known as the Reference DT-Anchor, serves as the central time reference for the network, generating a common ranging block structure and propagating synchronization information. The FiRa round can be divided into different periods, each allocated to a different ranging method. In one embodiment, a FiRa round starts with a time synchronization exchange for DL TDoA tracking, followed by a period for receiving tag blinks. Another embodiment involves a hybrid DL TDoA/TWR round, where time synchronization allows tags to confirm which anchors are in range, followed by TWR exchanges. The structure of the round is expressed by an out-of-band method, such as BLE or WiFi, which communicates information about the FiRa block structure. Different embodiments allow for various combinations of ranging methods, with the structure of each round being defined and communicated to ensure efficient operation and minimize collisions.

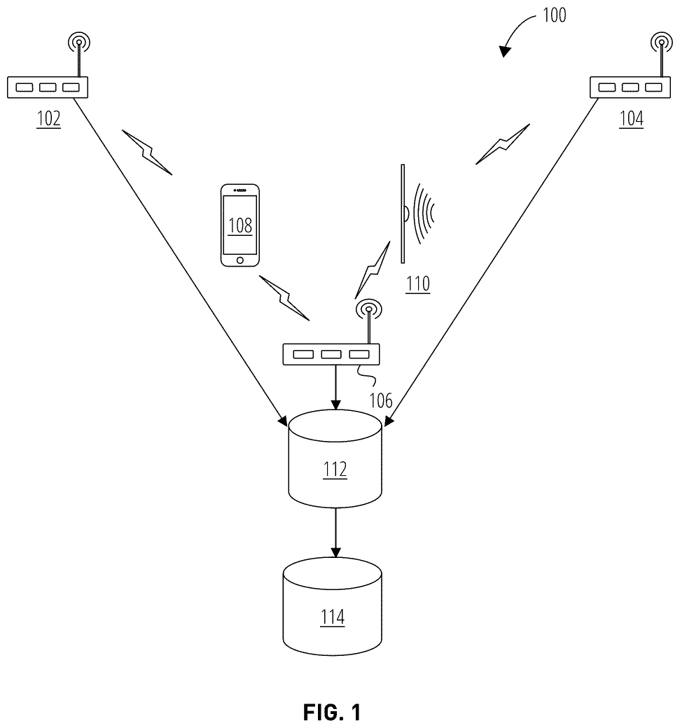

FIG. 1 illustrates an example environment operating based on FiRa (UWB) standard, according to some aspects of the present disclosure.

In one example, environment 100 (which may also be referred to as an ecosystem or architecture) includes a plurality of UWB anchors such as anchor 102, anchor 104, and anchor 106, a plurality of tags such as tag 108 and tag 110, a positioning server such as server 112, and an application layer server such as application layer server 114. It should be noted that environment 100 may include any other known or to be developed component such as additional servers, communication components, etc. Furthermore, the number of various components such as anchors and tags is not limited to that shown in FIG. 1 and may be more or less.

Each one of anchor 102, anchor 104, and anchor 106 may be a fixed device capable of emitting and receiving (transmitting and receiving) UWB signals. In one example, such UWB signals may be utilized to determine a distance between a given anchor and a given tag as will be described in more detail below. Each of anchor 102, anchor 104, and anchor 106 may be an access point (AP), a UWB base station, and/or any other device capable of transmitting and receiving UWB signals and communicating with co-located and/or cloud-based servers such as server 112 and application layer server 114.

A tag may be any device that includes a UWB transceiver capable of communicating with an anchor. In non-limiting example of FIG. 1, tag 108 is a mobile device and tag 110 may be any known or to be developed UWB tag that may be wearable and capable of tracking assets, people, vehicles, and equipment in various industrial and retail settings, etc.

Server 112 can be referred to as a positioning server. Server 112 can be any on-premise and/or cloud-based server that is capable of communicating with anchor 102, anchor 104, and/or anchor 106. For example, server 112 can receive raw data from anchor 102, anchor 104, and/or anchor 106 and process the data to determine location of tag 108 and/or tag 110. As will be described below, server 112 may also function as a central synchronizer, a central orchestrator, or a central reference generator to coordinate ranging blocks for FiRa and Omlox systems.

Server 112 may be implemented using any known or to be developed Real-Time Location Services (RTLS) server, a UWB server, any known or to be developed public, provider, or hybrid cloud server, etc.

Application layer server 114 may be a server executing software application to provide real-time location data to end users and applications. Such software application may be any known or to be developed application including, but not limited to, commercially available asset tracking systems, indoor navigation applications, etc.

In order to determine a location of a tag, each anchor (e.g., anchor 102) may receive a signal transmission (e.g., a beacon or a pulse) from a tag such as tag 108. Using Time Difference of Arrival (TDoA) or Two-Way Ranging (TWR), an anchor can determine a distance between that anchor and any tag with which the anchor communicates. The TDoA can be an Up Link TDOA (UL-TDoA) or a Down Link TDoA (DL-TDoA).

Determining a distance between an anchor and a tag is made possible using a ranging block. Each anchor (e.g., anchor 102, anchor 104, and anchor 106) and each tag (e.g., tag 108 and tag 110) has a ranging block. A ranging block can handle Time of Flight (ToF) or TDoA calculations for localization and ultimately location determination.

For example, using a ranging block, an anchor or a tag can send and receive UWB pulses and record timestamps associated with each. By measuring time delay between transmitted and received signals using techniques such as TWR, UL-TDoA, and/or DL-TDoA, a distance between the anchor and the tag can be determined. TWR is a technique whereby round-trip time between a tag and an anchor is measured using transmitted and received pulses. UL-TDoA and DL-TDoA are techniques whereby a difference in arrival time at multiple anchors is used to measure a distance between each anchor and a tag.

In order to accurately determine distances between anchors and tags, ranging blocks of anchors and/or tags are synchronized. This synchronization can be achieved via various techniques including, but not limited to, a shared clock signal by anchors, periodic UWB broadcast messages (can be broadcasted by server 112 or a designated master anchor (e.g., one of anchor 102, anchor 104, and anchor 106)), etc.

A ranging block may include several physical components including, but not limited to, a UWB transceiver, timing and clock synchronization unit, a signal processing unit, a data interface module, and a power management component. Specifications of a ranging block is defined by IEEE 802.15.4z specifications.

A ranging block may have a duration that refers to a time taken to complete a full ranging transaction between an anchor and a tag. The duration may be set according to the underlying ranging method used (e.g., TWR v. TDoA) and/or the required accuracy of location determination of assets (e.g., in a hospital v. a warehouse). For example, a duration of a ranging block may be set to 1 second. Each ranging block may include a plurality of ranging rounds. For instance, a ranging block can include 8 ranging rounds (4 active and 4 passive rounds), as will be further described below.

A ranging round is a complete cycle of message exchanges between a UWB tag and one or more UWB anchors to determine the distance (range) therebetween. Each ranging round consists of transmitting and receiving UWB pulses, recording timestamps, and performing distance calculations based on ToF and TDoA measurements.

Using distances determined by anchors and angle data from the anchors, server 112 can determine an accurate position of a given tag, which can be forwarded to application layer server 114 to be displayed in real-time on a terminal for asset tracking, navigation, and/or any other relevant application.

In some examples, environment 100 may require more than one ranging method within environment 100. In those instances, a central entity, (i.e., a designated Reference DT-Anchor, server 112, etc.) is the central time reference for an entire network. The central entity may identify one or more ranging methods associated with one or more devices within the network (e.g., UL TDoA, DL TDoA, TWR, etc.). The central entity may be configured by an administrator of the network. In some examples, the ranging methods may be identified by one or more signals associated with the one or more devices. The ranging methods may be based on a need associated with environment 100, such as navigation (e.g., DL TDoA and TWR) and/or asset tracking (e.g., UL TDoA and TWR). This central entity may generate the common ranging block structure and propagates synchronization information across the network (e.g., a network associated with environment 100). For example, server 112 may signal anchor 102, anchor 104, anchor 106, tag 108, and tag 110 to indicate the ranging block structure. In some examples, the central entity may transmit synchronization information to a portion of the devices on the network (e.g., anchor 102, but not anchor 104 or anchor 106). In such an example, only anchor 102 would participate in common ranging block structure propagated by the central entity. In some examples, the central entity may transmit a first block structure to a first portion and a second block structure to a second portion. The first block structure and the second block structure may utilize a single synchronization signal associated with the network, but may be configured differently to accommodate distinct ranging methods. The common ranging block for a ranging round may be implemented throughout the network and synchronized using the central entity. In some examples, the ranging block also be configured to accommodate Omlox rounds, if both standards (e.g., FiRa and Omlox) coexist on the network. The ranging block may be divided into different periods, each allocated to a different ranging method (e.g., DL TDoA, UL TDoA, and/or TWR).

In DL-TDOA, server 112 or an anchor initiates a data transfer poll, instructing the user device (tag) to record timestamps for signals from multiple anchors. These anchors, synchronized using GPS, PTP, or SyncE, transmit downlink signals at precisely known times. The tag receives these signals at slightly different times due to its varying distances from the anchors and records the timestamps. In response to the poll, the tag transmits these timestamps back to server 112, which calculates the Time Difference of Arrival (TDOA) between signals to determine the tag's location. Since synchronization is handled by the network, the tag does not require an accurate clock. Signaling requirements for DL TDoA include at least one data transfer poll and one or more poll responses.

In UL-TDOA, server 112 or an anchor sends a data transfer poll to the tag, requesting it to transmit an uplink signal. The tag responds by broadcasting a blink signal without requiring precise time synchronization. This blink signal is received at multiple anchors, which are tightly synchronized and record their respective arrival timestamps. The anchors then forward these timestamps to server 112, which calculates the TDOA between the signals at different anchors and determines the tag's position. Signaling requirements for UL TDoA include at least UL TDoA messages (UTMs) in the form of synchronization messages from a reference time source (e.g., server 112 or a primary anchor) and blink messages from tags (and optionally other anchors).

In TWR, server 112 or an anchor initiates a data transfer poll, instructing the user device (tag) to participate in a ranging exchange. The tag first receives a signal from one or more anchors and immediately responds with a reply. The one or more anchors record the Round Trip Time (RTT) between transmission and reception, factoring in the tag's response delay if known. This process may be repeated multiple times to improve accuracy. Server 112 or the one or more anchors then calculate the Time of Flight (ToF) and determines the distance between the tag and respective anchors, which can be used for positioning if multiple anchors participate in the exchange. Signaling requirements for TWR include at least form sets of four or more exchanges of unicast frames triggered by an anchor or a tag.

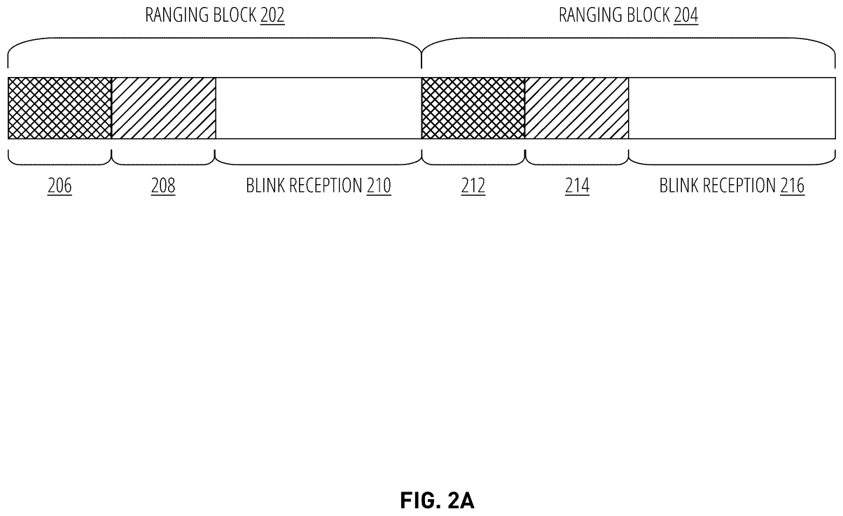

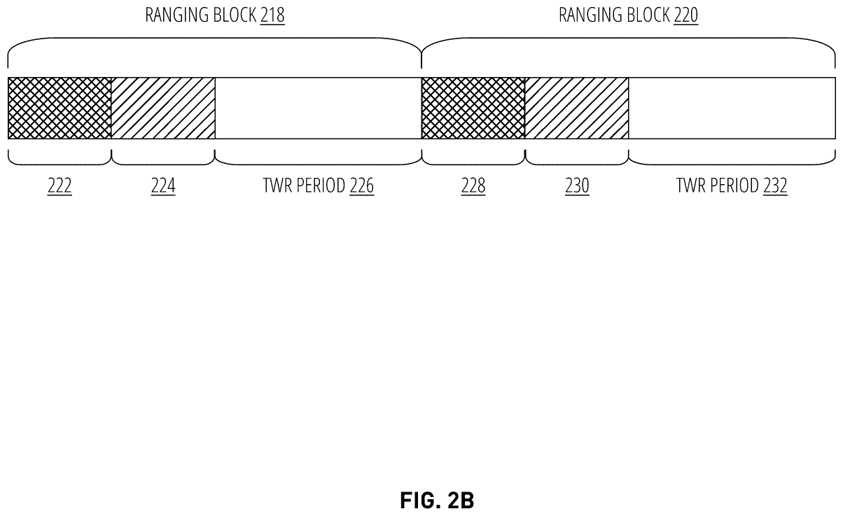

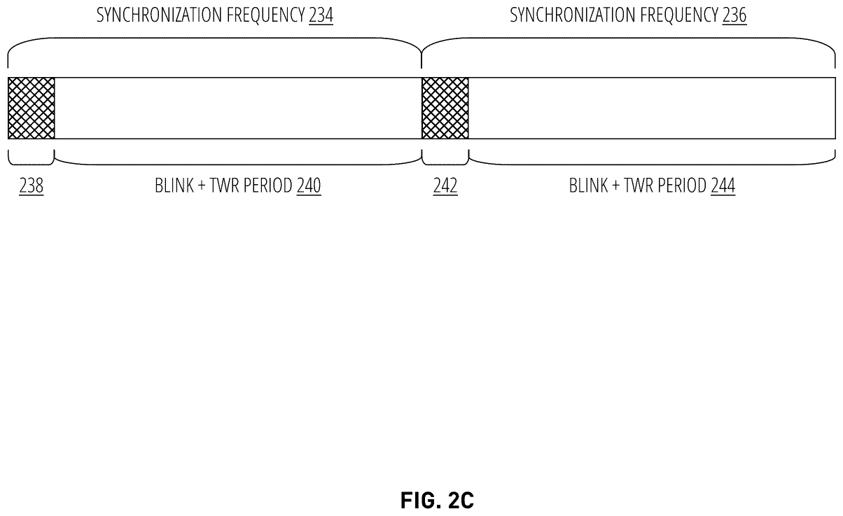

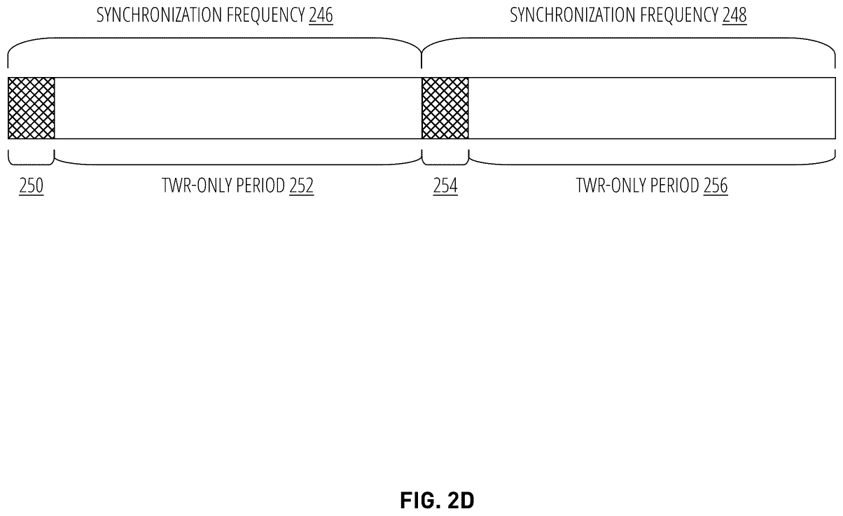

Thus, due to the different signaling requirements for the different ranging methods, standard format for ranging blocks may not accommodate two or more ranging methods within a single network due to potential collisions. FIG. 2A-FIG. 2D illustrate different FiRa ranging block structures to accommodate two or more ranging methods on a single network. The structure of a block may be expressed throughout the network by server 112 (or another managing central entity) using an out-of-band method (e.g., Bluetooth Low Energy, WiFi, etc.). In some examples, the structure may be expressed using an in-band method, such as UWB.

The out-of-band elements communicate data about a FiRa structure. This may include one or more ranging methods (e.g., UL TDoA, DL TDoA, and/or TWR); the duration of each period, round, and/or block associated with a particular ranging method; an order of block structure (e.g., a first block having a first structure, a second subsequent block having a second structure, a third subsequent block having the first structure, the fourth subsequent block having the second structure, etc.); start times and end times for a block; any combination thereof, or the like. In some examples, at server 112 (or another managing central entity) may access and/or store a reference table that includes one or more references to one or more block structures. The reference table may be accessible and/or shared to other components of environment 100 (e.g., anchor 102, anchor 104, anchor 106, tag 108, tag 110, etc.). Thus, for example, server 112 may signal “Block Structure A,” and the components of environment 100 may reference the reference table and identify the correct block structure to implement that corresponds to “Block Structure A.”

FIG. 2A illustrates a FiRa structure according to some aspects of the present disclosure. In some examples, an environment may implement DL TDoA and UL TDoA. The FiRa structure may include one or more ranging blocks (e.g., ranging block 202 and ranging block 204) that may include one or more active ranging rounds (e.g., ranging round 206, ranging round 208, ranging round 212, ranging round 214, etc.). In some examples, the FiRa structure may also include one or more passive rounds, such as blink reception 210 and blink reception 216. For example, 202 includes ranging round 206, ranging round 208, and blink reception 210.

At the beginning of a ranging block (e.g., ranging block 202 or ranging block 204), a central entity (e.g., server 112 as described in FIG. 1) may transmit a data transfer (DT) poll associated with DL TDoA (e.g., DL TDoA messages (DTMs)) to one or more components of a ranging network (e.g., anchor 102, anchor 104, anchor 106, tag 108, and/or tag 110 of environment 100 described in FIG. 1). The one or more components may include anchors and/or tags of the ranging network. The DT poll may initiate a DL TDoA procedure of ranging round 206. At ranging round 206, anchors of the ranging network may be synchronized (e.g., using GPS, PTP, SyncE, shared clock signal by anchors, periodic UWB broadcast messages (can be broadcasted by server 112 or a designated master anchor), any combination thereof, or the like) and may transmit downlink signals at precise times during ranging round 206. One or more tags of the ranging network may receive the downlink signals at slightly different times during ranging round 206 and may record timestamps associated with each respective downlink signal. The one or more tags may transmit the timestamps during ranging round 206 to the central entity for processing. This process may be repeated at ranging round 208.

Blink reception 210 may be incorporated into the FiRa structure to accommodate UL TDoA. The anchors of the ranging network may be synchronized using the DT poll of ranging round 206 and/or ranging round 208. The central entity may transmit a DT poll associated with UL TDoA (e.g., UL TDoA messages (UTMs)). In some examples, the DT poll may be transmitted at the start of blink reception 210. After receipt of the DT poll UTM, the one or more tags of the ranging network may transmit blink signals. Blink reception 210 may be a segment of the FiRa structure that is reserved for receiving the blink signals at the anchors of the ranging network (e.g., a passive round). The anchors on the network may be configured to decode the incoming blink signals from the one or more tags over the duration of blink reception 210. After receipt of the blink signals at the anchors of the ranging network, the anchors may transmit respective timestamps associated with receipt of the blink signals to the central entity.

The central entity may receive timestamps associated with ranging round 206, ranging round 208 and/or blink reception 210, and may calculate the TDOA between the timestamps and identify a location of the one or more tags within the ranging network. In some examples, ranging block 202 may be repeated for a duration of time (e.g., ranging block 204, which includes at least ranging round 212, ranging round 214, and blink reception 216).

FIG. 2B illustrates a FiRa structure according to some aspects of the present disclosure. In some examples, an environment may incorporate DL TDoA and TWR. The FiRa structure may include one or more ranging blocks, including ranging block 218 and ranging block 220. The ranging blocks may be comprised of one or more ranging rounds (e.g., ranging round 222, ranging round 224, ranging round 228, and ranging round 230) and one or more TWR periods (e.g., TWR period 226 and TWR period 232). The ranging blocks may be configured to accommodate DL TDoA and TWR ranging methods.

At the beginning of a ranging block (e.g., ranging block 218 or ranging block 220), a central entity (e.g., server 112 as described in FIG. 1) may transmit a data transfer (DT) poll DTM to one or more components of a ranging network (e.g., anchor 102, anchor 104, anchor 106, tag 108, and/or tag 110 of environment 100 described in FIG. 1). The one or more components may include anchors and/or tags of the ranging network. The DT poll may initiate a DL TDoA procedure of ranging round 222. At ranging round 222, anchors of the ranging network may be synchronized (e.g., using GPS, PTP, SyncE, shared clock signal by anchors, periodic UWB broadcast messages (can be broadcasted by server 112 or a designated master anchor), any combination thereof, or the like) and may transmit downlink signals at precise times during ranging round 222. One or more tags of the ranging network may receive the downlink signals at slightly different times during ranging round 222 and may record timestamps associated with each respective downlink signal. The one or more tags may transmit the timestamps during ranging round 222 to the central entity for processing. This process may be repeated at ranging round 224.

TWR period 226 may be incorporated into the FiRa structure to accommodate TWR ranging methods. In some examples, the TWR devices associated with the ranging network may identify the timing of TWR period 226 (e.g., based on the DL TDoA timing, based on signaling from the central entity, any combination thereof, or the like). The central entity may transmit a DT poll instructing the one or more tags of the ranging network to participate in a ranging exchange. In some examples, the DT poll may be transmitted at the start of TWR period 226. The one or more tags may receive blink signals from the anchors of the ranging network and may, in response to receipt of the blink signals, immediately respond with a reply. The respective anchors may record the RTT between transmission and reception, factoring in a response delay associated with the one or more tags, if applicable. In some examples, this ranging exchange may occur more than once. The respective anchors may transmit the RTT to the central entity for processing.

In some examples, the process of ranging block 218 may be repeated for a duration of time (e.g., ranging block 220, that includes at least ranging round 228, ranging round 230, and TWR period 232).

FIG. 2C illustrates a FiRa structure according to some aspects of the present disclosure. In some examples, an environment may incorporate UL TDoA and TWR. The FiRa structure may include one or more ranging blocks, distinguished according to a synchronization frequency (e.g., a duration of time between synchronization signals on a ranging network). For example, synchronization frequency 234 may distinguish a first ranging block and synchronization frequency 236 may distinguish a second ranging block. Synchronization frequency 234 may include sync 238 and blink+TWR period 240. Synchronization frequency 236 may include sync 242 and blink+TWR period 244. The ranging blocks may be configured to accommodate UL TDoA and TWR ranging methods.

Blink+TWR period 240 may be incorporated into the FiRa structure (distinguished by synchronization frequency 234) to accommodate UL TDoA and TWR in combination. The anchors of the ranging network may be synchronized using sync 238. The central entity may transmit a DT poll UTM. After receipt of the DT poll UTM, the one or more tags of the ranging network may transmit blink signals. Blink+TWR period 240 may be a segment of the FiRa structure that is reserved for receiving the blink signals at the anchors of the ranging network (e.g., a passive round). The anchors on the network may be configured to decode the incoming blink signals from the one or more tags over the duration of blink+TWR period 240. After receipt of the blink signals at the anchors of the ranging network, the anchors may transmit respective timestamps associated with receipt of the blink signals to the central entity.

In some examples, blink+TWR period 240 may also accommodate the TWR signaling method. In some examples, the TWR devices (tags) associated with the ranging network may identify the timing of blink+TWR period 240 based on sync 238. The central entity may transmit a DT poll instructing the one or more tags of the ranging network to participate in a ranging exchange. The one or more tags may receive blink signals from the anchors of the ranging network and may, in response to receipt of the blink signals, immediately respond with a reply. The respective anchors may record the RTT between transmission and reception, factoring in a response delay associated with the one or more tags, if applicable. In some examples, this ranging exchange may occur more than once. The respective anchors may transmit the RTT to the central entity for processing. This process may be repeated for subsequent ranging blocks, for example, as distinguished by synchronization frequency 236 (e.g., including sync 242 and blink+TWR period 244).

In another embodiment, blink+TWR period 240 may be further segmented into two reception periods (e.g., a UL TDoA blink reception period and a TWR reception period). For example, a period of a set duration immediately following sync 238 may be designated as a UL TDoA blink reception period, and a second period of a set duration immediately following the UL TDoA blink reception period (but before the next sync 242) may be designated as a TWR reception period.

FIG. 2D illustrates a FiRa structure according to some aspects of the present disclosure. Similarly to FIG. 2C, an environment may incorporate UL TDoA and TWR. The FiRa structure may include one or more ranging blocks, distinguished according to a synchronization frequency (e.g., a duration of time between synchronization signals on a ranging network). For example, synchronization frequency 246 may distinguish a first ranging block and synchronization frequency 248 may distinguish a second ranging block. Synchronization frequency 246 may include sync 250 and TWR-only period 252. Synchronization frequency 248 may include sync 254 and TWR-only period 256. The ranging blocks may be configured to accommodate UL TDoA and TWR ranging methods.

In some examples, TW R-only period 252 may utilize TWR signaling to perform a TDoA operation (e.g., similarly to UL TDoA). For example, the ranging network may include one or more anchors. The ranging network may also include a tag (for illustrative purposes only, the ranging network may include a single tag, but the ranging network may be scaled up to include more than one tag in some examples). The tag may perform TWR using a first portion of the one or more anchors. The first portion of the one or more anchors may, in response to a DT poll from a central entity, transmit a signal to the tag. In response to the signal the tag may distribute a response signal to the one or more anchors of the ranging network. The first portion of the one or more anchors may receive the response signal and record the RTT (e.g., perform TWR ranging method), while a second portion of the one or more anchors may receive the response signal and record respective arrival timestamps (e.g., perform UL TDoA ranging method). The first portion of the one or more anchors may transmit the RTT to the central entity and the second portion of the one or more anchors may transmit the respective arrival timestamps to the central entity. Thus, signaling is simplified by eliminating the need for transmitting blink signals associated with UL TDoA. This process may be repeated for subsequent ranging blocks, for example, as distinguished by synchronization frequency 248 (e.g., including sync 254 and TWR-only period 256).

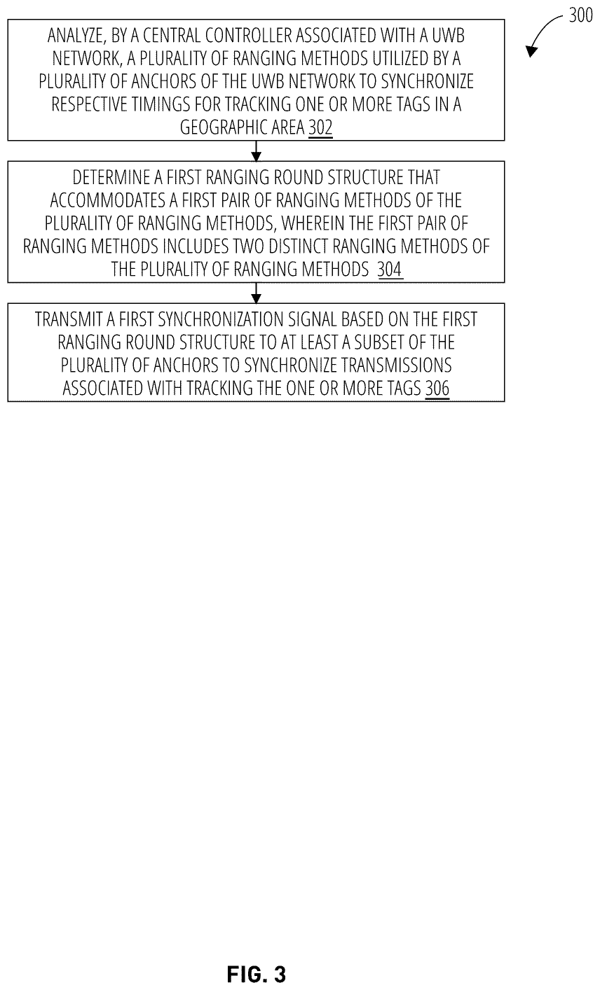

FIG. 3 illustrates a method 300 for implementing a FiRa structure according to some aspects of the present disclosure. In block 302 of method 300 a central controller analyzes a plurality of ranging methods utilized by a plurality of anchors of a UWB network to synchronize respective timings for tracking one or more tags in a geographic area. For example, server 112 (as described in FIG. 1) may analyze the plurality of ranging methods utilized by the plurality of anchors of the UWB network (e.g., anchor 102, anchor 104, and anchor 106, as described in FIG. 1) to synchronize respective timings for tracking one or more tags (e.g., tag 108 and tag 110) in environment 100 (as described in FIG. 1). In some examples, a network may require more than one ranging method within environment. In those instances, a central entity, (i.e., a designated Reference DT-Anchor, server 112, etc.) is the central time reference for an entire network. The central entity may identify one or more ranging methods associated with one or more devices within the network (e.g., UL TDoA, DL TDoA, TWR, etc.). The ranging methods may be identified by one or more signals associated with the one or more devices.

In block 304 of method 300 the central controller determines a first ranging round structure that accommodates a first pair of ranging methods of the plurality of ranging methods, wherein the first pair of ranging methods includes two distinct ranging methods of the plurality of ranging methods. For example, server 112 may determine a first ranging round structure that accommodates a first pair of ranging methods of the plurality of ranging methods, where the first pair of ranging methods includes two distinct ranging methods of the plurality of ranging methods. The central controller may generate the common ranging block structure and propagates synchronization information across the network (e.g., a network associated with environment 100). For example, the central controller may signal one or more anchors and/or one or more tags to indicate the ranging block structure. The common ranging block for a ranging round may be implemented throughout the network and synchronized using the central server. In some examples, the ranging block also be configured to accommodate Omlox rounds, if both standards (e.g., FiRa and Omlox) coexist on the network. The ranging block may be divided into different periods, each allocated to a different ranging method (e.g., DL TDoA, UL TDoA, and/or TWR).

In block 306 of method 300 the central controller transmits, a first synchronization signal based on the first ranging round structure to at least a subset of the plurality of anchors to synchronize transmissions associated with tracking the one or more tags. For example, server 112 may transmit the first synchronization signal based on the first ranging round structure to at least a subset of the plurality of anchors (e.g., anchor 102, anchor 104, and anchor 106) to synchronize transmissions associated with tracking the one or more tags (e.g., tag 108 and tag 110).

The structure of a block may be expressed throughout the network by the central server using an out-of-band method (e.g., Bluetooth Low Energy, WiFi, etc.). The out-of-band elements communicate data about a FiRa structure. This may include one or more ranging methods (e.g., UL TDoA, DL TDoA, and/or TW R); the duration of each period, round, and/or block associated with a particular ranging method; an order of block structure (e.g., a first block having a first structure, a second subsequent block having a second structure, a third subsequent block having the first structure, the fourth subsequent block having the second structure, etc.); start times and end times for a block; any combination thereof, or the like. In some examples, the central server may access and/or store a reference table that includes one or more references to one or more block structures. The reference table may be accessible and/or shared to other components of the network (e.g., anchor 102, anchor 104, anchor 106, tag 108, tag 110, etc., as described in FIG. 1). Thus, for example, the central server may signal “Block Structure A,” and the components of the network may reference the reference table and identify the correct block structure to implement that corresponds to “Block Structure A.”

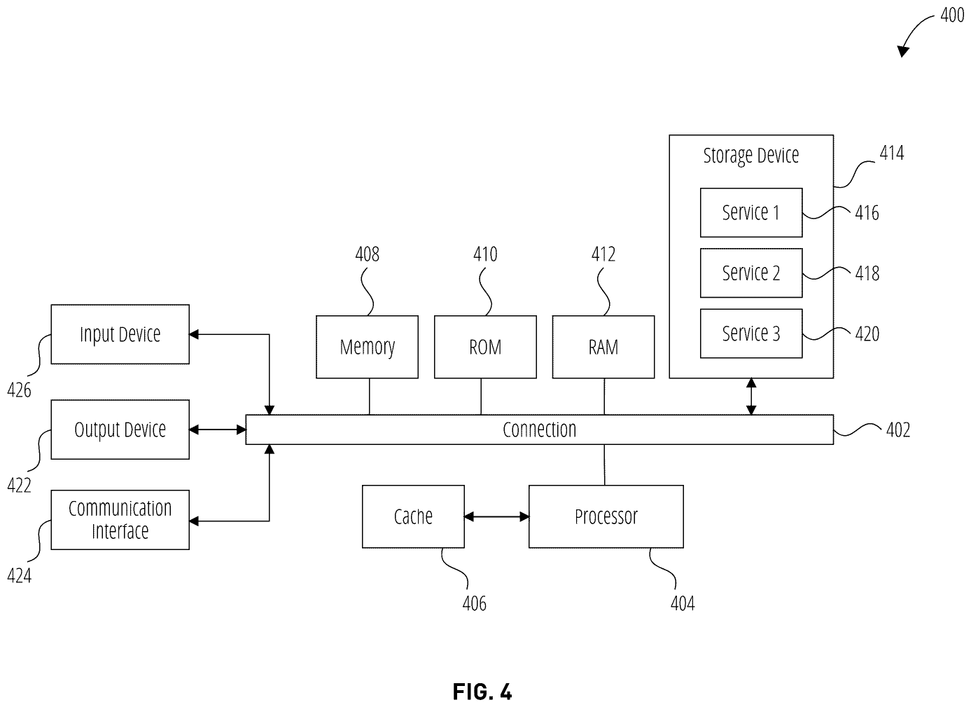

FIG. 4 shows an example of computing system 400, which can be for example any computing device making up a ranging network and/or environment (e.g., environment 100 as described in FIG. 1) or any component thereof in which the components of the system are in communication with each other using connection 402. Connection 402 can be a physical connection via a bus, or a direct connection into processor 404, such as in a chipset architecture. Connection 402 can also be a virtual connection, networked connection, or logical connection.

In some embodiments, computing system 400 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 400 includes at least one processing unit (CPU or processor) 404 and connection 402 that couples various system components including system memory 408, such as read-only memory (ROM) 410 and random access memory (RAM) 412 to processor 404. Computing system 400 can include a cache of high-speed memory 406 connected directly with, in close proximity to, or integrated as part of processor 404.

Processor 404 can include any general purpose processor and a hardware service or software service, such as services 416, 418, and 420 stored in storage device 414, configured to control processor 404 as well as a special-purpose processor where software instructions are incorporated into the actual processor design. Processor 404 may essentially be a completely self-contained computing system, containing multiple cores or processors, a bus, memory controller, cache, etc. A multi-core processor may be symmetric or asymmetric.

To enable user interaction, computing system 400 includes an input device 426, which can represent any number of input mechanisms, such as a microphone for speech, a touch-sensitive screen for gesture or graphical input, keyboard, mouse, motion input, speech, etc. Computing system 400 can also include output device 422, which can be one or more of a number of output mechanisms known to those of skill in the art. In some instances, multimodal systems can enable a user to provide multiple types of input/output to communicate with computing system 400. Computing system 400 can include communication interface 424, which can generally govern and manage the user input and system output. There is no restriction on operating on any particular hardware arrangement, and therefore the basic features here may easily be substituted for improved hardware or firmware arrangements as they are developed.

Storage device 414 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 414 can include software services, servers, services, etc., that when the code that defines such software is executed by the processor 404, it causes the system to perform a function. In some embodiments, a hardware service that performs a particular function can include the software component stored in a computer-readable medium in connection with the necessary hardware components, such as processor 404, connection 402, output device 422, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A computer-implemented method, comprising:
analyzing, by a controller associated with an Ultra-Wide Band (UWB) network, a plurality of ranging methods utilized by a plurality of anchors of the UWB network to synchronize respective timings for tracking one or more tags in a geographic area;
determining a first ranging round structure that accommodates a first pair of ranging methods of the plurality of ranging methods, wherein the first pair of ranging methods includes two distinct ranging methods of the plurality of ranging methods; and
transmitting a first synchronization signal based on the first ranging round structure to at least a subset of the plurality of anchors to synchronize transmissions associated with tracking the one or more tags.

2. The computer-implemented method of claim 1, further comprising:
determining a second ranging round structure that accommodates a second pair of ranging methods of the plurality of ranging methods, wherein the second pair of ranging methods includes two distinct ranging methods of the plurality of ranging methods; and
transmitting a second synchronization signal based on the second ranging round structure to at least the subset of the plurality of anchors, wherein the second ranging round structure is sequential to the first ranging round structure, wherein the second ranging round structure accommodates a second pair of ranging methods, and wherein the second pair of ranging methods is comprised of two distinct ranging methods of the plurality of ranging methods.

3. The computer-implemented method of claim 2, wherein the second ranging round structure is different from the first ranging round structure, and wherein the second pair of ranging methods is distinct from the first pair of ranging methods.

4. The computer-implemented method of claim 2, further comprising:
transmitting, by the controller, instructions associated with the first ranging round structure or the second ranging round structure to at least the subset of the plurality of anchors of the UWB network.

5. The computer-implemented method of claim 1, wherein the first ranging round structure is transmitted by the controller using an out-of-band method.

6. The computer-implemented method of claim 1, wherein the plurality of ranging methods include at least Two-Way Ranging (TWR), Uplink Time Difference of Arrival (UL TDoA), and Downlink TDoA (DL TDoA).

7. The computer-implemented method of claim 1, wherein the first ranging round structure is sub-divided into one or more segments, wherein each segment of the one or more segments is associated with at least one of a respective ranging method and a synchronization signal.

8. A system comprising:
one or more processors; and
a memory storing instructions that, when executed by the one or more processors, configure the system to:
analyze, by a controller associated with an Ultra-Wide Band (UWB) network, plurality of ranging methods utilized by a plurality of anchors of the UWB network to synchronize respective timings for tracking one or more tags in a geographic area;
determine a first ranging round structure that accommodates a first pair of ranging methods of the plurality of ranging methods, wherein the first pair of ranging methods includes two distinct ranging methods of the plurality of ranging methods; and
transmit a first synchronization signal based on the first ranging round structure to at least a subset of the plurality of anchors to synchronize transmissions associated with tracking the one or more tags.

9. The system of claim 8, wherein the instructions further configure the system to:
determine a second ranging round structure that accommodates a second pair of ranging methods of the plurality of ranging methods, wherein the second pair of ranging methods includes two distinct ranging methods of the plurality of ranging methods; and
transmit a second synchronization signal based on the second ranging round structure to at least another subset of the plurality of anchors, wherein the second ranging round structure is sequential to the first ranging round structure, wherein the second ranging round structure accommodates a second pair of ranging methods, and wherein the second pair of ranging methods is comprised of two distinct ranging methods of the plurality of ranging methods.

10. The system of claim 9, wherein the second ranging round structure is different from the first ranging round structure, and wherein the second pair of ranging methods is distinct from the first pair of ranging methods.

11. The system of claim 9, wherein the instructions further configure the system to:
transmit, by the controller, instructions associated with the first ranging round structure or the second ranging round structure to at least the subset of the plurality of anchors of the UWB network.

12. The system of claim 8, wherein the first ranging round structure is transmitted by the controller using an out-of-band method.

13. The system of claim 8, wherein the plurality of ranging methods include at least Two-Way Ranging (TWR), Uplink Time Difference of Arrival (UL TDoA), and Downlink TDoA (DL TDoA).

14. The system of claim 8, wherein the first ranging round structure is sub-divided into one or more segments, wherein each segment of the one or more segments is associated with at least one of a respective ranging method and a synchronization signal.

15. A non-transitory computer-readable storage medium, the non-transitory computer-readable storage medium including instructions that when executed by a computer, cause the computer to:
analyze, by a controller associated with an Ultra-Wide Band (UWB) network, plurality of ranging methods utilized by a plurality of anchors of the UWB network to synchronize respective timings for tracking one or more tags in a geographic area;
determine a first ranging round structure that accommodates a first pair of ranging methods of the plurality of ranging methods, wherein the first pair of ranging methods includes two distinct ranging methods of the plurality of ranging methods; and
transmit a first synchronization signal based on the first ranging round structure to at least a subset of the plurality of anchors to synchronize transmissions associated with tracking the one or more tags.

16. The non-transitory computer-readable storage medium of claim 15, wherein the instructions further configure the computer to:
determine a second ranging round structure that accommodates a second pair of ranging methods of the plurality of ranging methods, wherein the second pair of ranging methods includes two distinct ranging methods of the plurality of ranging methods; and
transmit a second synchronization signal based on the second ranging round structure to at least another subset of the plurality of anchors, wherein the second ranging round structure is sequential to the first ranging round structure, wherein the second ranging round structure accommodates a second pair of ranging methods, and wherein the second pair of ranging methods is comprised of two distinct ranging methods of the plurality of ranging methods.

17. The non-transitory computer-readable storage medium of claim 16, wherein the second ranging round structure is different from the first ranging round structure, and wherein the second pair of ranging methods is distinct from the first pair of ranging methods.

18. The non-transitory computer-readable storage medium of claim 16, wherein the instructions further configure the computer to:
transmit, by the controller, instructions associated with the first ranging round structure or the second ranging round structure to at least the subset of the plurality of anchors of the UWB network.

19. The non-transitory computer-readable storage medium of claim 15, wherein the first ranging round structure is transmitted by the controller using an out-of-band method.

20. The non-transitory computer-readable storage medium of claim 15, wherein the plurality of ranging methods include at least Two-Way Ranging (TWR), Uplink Time Difference of Arrival (UL TDoA), and Downlink TDoA (DL TDoA).
